(19) United States
(12) Patent Application Publication
(10) Pub. No.: US 2009/0324246 A1
(43) Pub. Date: Dec. 31, 2009

(54) Method of Limiting the Non-Linear Phase Noise of a Phase-Modulated Optical Signal of Constant Amplitude, and an Associated Device

(75) Inventors: Erwan Pincemin, Gommenec'h (FR); Christophe Gosset, Sainte Genevieve Des Bois (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: FRANCE TELECOM, Paris (FR)

(21) Appl. No.: 12/492,715

(22) Filed: Jun. 26, 2009

(30) Foreign Application Priority Data
Jun. 27, 2008 (FR) 08/54307

(51) Int. Cl. H04B 10/00

(52) U.S. Cl. 398/158

(57) ABSTRACT

A non-linear phase noise limiter device limits the non-linear phase noise that affects a phase-modulated input optical signal of constant mean amplitude conveyed over a transmission line. The device is placed at a zero dispersion point of the transmission line, and it is suitable for suppressing amplitude fluctuations about a mean value in said optical signal.

### CROSS-REFERENCE TO RELATED APPLICATIONS

None.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The field of the disclosure is that of telecommunications, and more particularly that of optical fiber telecommunications.

The present disclosure relates to a non-linear phase noise limiter device for limiting the non-linear phase noise that affects a phase-modulated optical signal at constant amplitude conveyed by an optical fiber transmission line.

The disclosure applies in particular to a phase-modulated optical signal of constant amplitude or power, in particular a signal modulated with a format of the M-ary phase shift keying (M-PSK) type, e.g. of the binary, quaternary, or 2^{N} type (B-PSK, Q-PSK, 2^{N}-PSK).

### BACKGROUND OF THE DISCLOSURE

This type of format is presently in ever-increasing use for optical fiber transmission over long distances. An advantage of this type of format is that it can be coupled with coherent detection and with digital signal processing (DSP) algorithms implemented in a dedicated electronic circuit, thereby making it possible to compensate imperfections introduced by the propagation channel, such as chromatic dispersion (CD) and polarization mode dispersion (PMD), which imperfections accumulate in the optical signal as it travels along the transmission line.

Coherent detection is linear with respect to the signal and enables both the amplitude and the phase of the optical signal to be obtained, thereby making it possible, where necessary, to correct the imperfections therein (in particular CD and PDM) digitally by using such DSP algorithms. In contrast, quadrature detection is proportional to the square of the optical signal field, thereby having the effect of eliminating phase information. It therefore does not enable effective digital signal processing to be performed, and it does not enable CD and PMD to be compensated.

M-PSK type phase modulation also includes multi-level modulation that presents the advantage of presenting a symbol rate that is lower than the binary rate, thereby enabling the data rate to be raised to above that allowed by the RF and opto-electronic components of the transmission line. Such components are limited in the electrical passband to frequencies well below 100 gigahertz (GHz) (presently typically 50 GHz). Thus, 100 gigabytes per second (Gb/s) transmission lines can be made nowadays using an M-PSK format, whereas they cannot be made using a format that implements amplitude modulation known as on-off keying (OOK) for which the symbol rate is equal to the binary data rate.

A major drawback of the M-PSK type phase modulation format is that it is sensitive to distortion introduced by the non-linear effects that are excited in the transmission optical fiber, and in particular the Kerr effect.

The Kerr effect is responsible for the refractive index of the transmission optical fiber being modulated as a function of the intensity of the optical signal it is conveying. Such modulation gives rise to variation in the phase of the optical signal being conveyed, which phase variation depends on the power of that signal.

The Kerr effect is excited by the amplitude noise that affects the optical signal, itself generated by the amplified spontaneous emission (ASE) noise generated by the cascade of optical amplifiers that are incorporated at regular intervals along the transmission line in order to regenerate the amplitude of the optical signal being conveyed. The amplitude fluctuations or amplitude noise generated by ASE noise affects the optical signal by acting on the refractive index of the optical fiber via the Kerr effect. They give rise to fluctuations of phase (or phase noise) in the signal, which phase fluctuations are proportional to the instantaneous power of the signal. These phase fluctuations are particularly large when the instantaneous power of the optical signal is at its greatest. Unfortunately, with M-PSK type modulation, it is the phase of the optical signal that carries the useful binary information. As a result, such non-linear phase noise progressively pollutes the useful information carried by the optical signal.

Document EP 1 544 669 describes a method and a device for limiting the phase noise generated by an optical fiber transmission line in an optical signal that is modulated using the differential phase-shift keying (D-PSK) format. Such a device includes means for converting the conveyed optical signal into an amplitude modulated signal of the OOK type. Such format conversion has the effect of also converting the phase noise into amplitude noise that affects the “1s” and the “0s” of the OOK signal. The limiter device also includes means for suppressing amplitude fluctuations in the 0 symbols and the 1 symbols of the converted signal and means for performing the inverse conversion from the converted signal back into a phase-modulated signal after the amplitude fluctuations have been suppressed.

In an embodiment, the amplitude fluctuation suppressor means are implemented by an ideal saturable absorber so as to stabilize the amplitude fluctuations of the “1s” and the “0s” of the OOK type optical signal. Such a component is a passive optical component that is simple to implement.

A first drawback of such a device is that it requires amplitude fluctuations to be suppressed on two intensity levels “1” and “0”, and that is difficult to achieve since such two-level suppression requires the saturable absorber to present a transfer function that is close to ideal in the form of a staircase. Existing components turn out to very effective at cleaning “0s”, but their performance is not so good for “1” levels.

A second drawback of such a device lies in its complexity and its cost, due to the presence of a phase-to-amplitude converter and of an amplitude-to-phase converter.

### SUMMARY

An illustrative, non-limiting aspect of the disclosure seeks to improve the situation with the help of a non-linear phase noise limiter device for limiting the non-linear phase noise that affects a phase-modulated input optical signal of constant mean amplitude conveyed over a transmission line.

According to an aspect of the disclosure, said device is placed at a zero dispersion point of the transmission line, and it is suitable for implementing means for suppressing amplitude fluctuations about a mean value in said optical signal.

The optical signal transmitted at the input of the transmission line presents a constant amplitude value with the useful information being carried by the phase modulation. While it is being conveyed over a fraction of the line, amplitude fluctuations appear around the constant input value. By suppressing the amplitude fluctuations around this mean amplitude value of the optical signal as conveyed, the device makes it possible to keep the amplitude of the optical signal constant and thus to limit the accumulation of non-linear phase noise due to the ASE noise effect over an optical fiber span downstream from the transmission line. By modifying the non-linear index of the optical fiber of the transmission line, it is these amplitude fluctuations that generate phase noise having a value that is proportional to the power of the optical signal. By suppressing the amplitude fluctuations in the signal presented at the input to a downstream optical fiber span, the device suppresses the cause that makes the additional phase noise appear.

Such a device is placed at a point of zero accumulated chromatic dispersion, i.e. a point where the action of chromatic dispersion on the conveyed optical signal is zero. At such a point, the amplitude fluctuations in the conveyed optical signal are due solely to the ASE noise of the optical amplifiers of the transmission line.

Thus, an illustrative aspect of the disclosure relies on an approach that is entirely novel and inventive and that enables the accumulation of phase noise along a transmission line to be limited by directly cleaning the phase-modulated optical signal in such a manner as to present a phase-modulated optical signal to the input of an optical fiber span that presents amplitude that is constant, without the amplitude fluctuations that cause non-linear phase noise to be generated.

It will be understood that if phase noise accumulates upstream from the device according to an aspect of the disclosure, it is not suppressed, but that the device serves to avoid additional phase noise accumulating downstream therefrom.

With an aspect of the disclosure, it is thus no longer necessary to convert the optical signal into an amplitude-modulated signal, e.g. using the OOK amplitude modulation format.

An aspect of the disclosure thus proposes a solution for limiting the accumulation of non-linear phase noise in an optical signal conveyed over an optical fiber transmission line, which solution is simpler and less expensive.

According to an aspect of the disclosure, the means for suppressing amplitude fluctuations are suitable for transforming an input signal presenting a mean amplitude lying within a predetermined range into an output signal presenting a constant output amplitude.

It will be understood that the amplitude fluctuation suppressor means of an aspect of the disclosure present a staircase transfer function that peak-limits amplitude fluctuations around a certain input amplitude level and delivers an output of constant amplitude.

According to an aspect of the disclosure, the amplitude fluctuation suppressor means are implemented by a transparent saturable absorber type component.

A transparent saturable absorber is an optical component adapted, for an input optical signal of power Pᵢₙ greater than a predetermined threshold Pᵢₙ₁, to deliver an output signal of constant power Pₒᵤₜ₁. Consequently, for an input power lying in a given range of values, it implements the staircase transfer function that cuts off amplitude fluctuations in the input signal that are situated beyond the power threshold Pᵢₙ₁. Such a component is known to the person skilled in the art and is described in detail in the document entitled “New passive all-optical semiconductor for bit-1 level noise reduction” by Oudar et al., published in the Proceedings of the European Conference “Lasers and Electro-optics and the International Quantum Electronics CLEOE-IQEC 2007” in June 2007.

Nevertheless, it should be observed that aspects of the disclosure are not limited to this particular example of a component, and could make use of any other optical component that presents the same transfer function and that does not modify the phase of the optical signal it processes.

The disclosure also provides a method of limiting non-linear phase noise in a phase-modulated optical signal of constant mean amplitude conveyed over a transmission line.

According to an illustrative example, the method implements, at a zero dispersion point in the transmission line, a step of suppressing amplitude fluctuations in said signal about its mean value.

Finally, an aspect of the disclosure provides an optical fiber transmission system (transmission line) comprising at least first and second transmission modules, the first transmission module comprising:

a transmission optical fiber span suitable for conveying the optical signal;

in-line amplifier means suitable for amplifying said optical signal as output from the optical fiber span; and

chromatic dispersion compensation means suitable for providing an amplified optical signal in which the effects of chromatic dispersion are canceled.

According to an aspect of the disclosure, such a system includes, at the output from the compensation means of the first transmission module, a non-linear phase noise limiter device according to an aspect of the disclosure.

The output point from the chromatic dispersion compensation means constitutes a zero dispersion point. It is at this point that it is possible to place a non-linear phase noise limiter module. It should be observed that such a system may comprise a plurality of transmission modules. Under such circumstances, it has a plurality of zero accumulated dispersion points that are located regularly along the transmission line. These points constitute potential locations for respective non-linear phase noise limiter devices according to one or more aspects of the disclosure. One or more phase noise limiter devices may thus advantageously be located at those points, but not necessarily at each zero dispersion point of the transmission line.

Advantageously, the number of phase noise limiter devices that suffices in a transmission line to obtain satisfactory non-linear phase noise limitation is defined by the engineering design rules of the operator of the optical transmission network.

### BRIEF DESCRIPTION OF THE DRAWINGS

Other advantages and characteristics appear more clearly on reading the following description of a particular embodiment given merely by way of illustrative and non-limiting example, and from the accompanying drawings, in which:

FIG. 1 shows a non-linear phase noise limiter device according to an aspect of the disclosure, in its environment;

FIG. 2 shows the steps of the phase noise limitation method according to an aspect of the disclosure;

FIG. 3 shows how non-linear phase noise varies along a transmission line with and without a noise limiter device according to an aspect of the disclosure;

FIG. 4 shows the transfer function of a transparent saturable absorber implemented by the non-linear phase noise limiter device in an aspect of the disclosure; and

FIG. 5 is a diagram showing an example of an optical transmission system of the disclosure.

### DETAILED DESCRIPTION OF ILLUSTRATIVE EMBODIMENTS

The general principle of an exemplary aspect of the disclosure relies on eliminating amplitude fluctuations around a mean amplitude value of a phase-modulated optical signal that is being conveyed by an optical fiber transmission line. Such suppression of fluctuations makes it possible to maintain the power of the optical signal constant and thus to limit the generation of non-linear phase noise during propagation by interaction of the phase-modulated signal with the optical fiber and by excitation of non-linear effects.

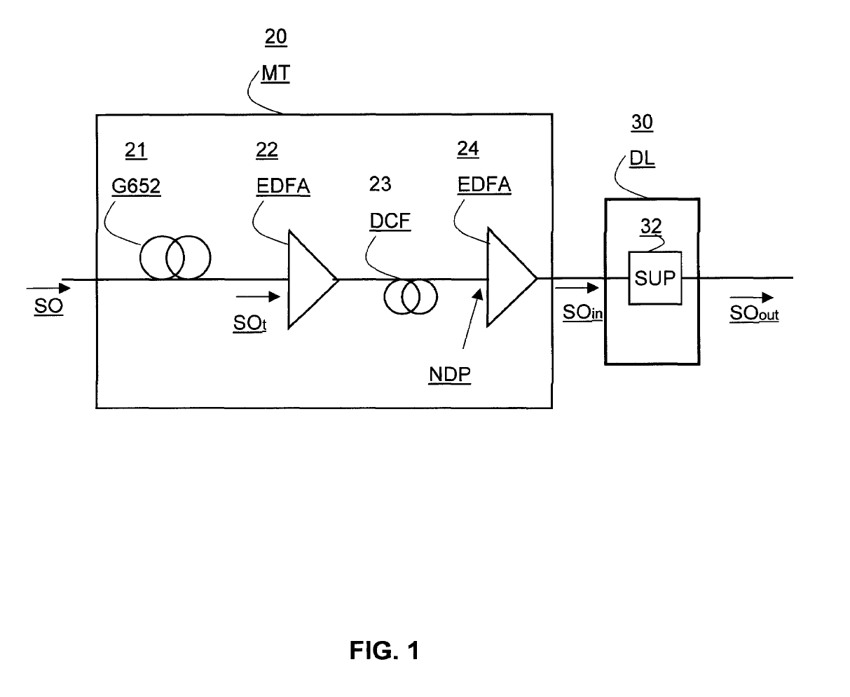

With reference to FIG. 1, there can be seen a diagram of a phase noise limiter device DL 30 according to an exemplary aspect of the disclosure, in its environment. In the example of FIG. 1, there is shown a portion of a transmission line comprising a transmission module MT 20 and the device DL 30. Such a span may be placed anywhere along the transmission line between the transmitter and the receiver.

In this example, the optical signal is carried on a wavelength of 1550 nanometers (nm).

The optical signal is then cleaned by an amplitude suppressor module SUP 32 for suppressing amplitude fluctuations about a mean amplitude value. The resulting output optical signal SOₒᵤₜ is conveyed on the transmission line.

According to an aspect of the disclosure, the phase noise limiter device DL 30 is placed at a zero or null dispersion point NDP, i.e. a point where the effects of chromatic dispersion have been canceled. Such compensation is performed upstream from the non-linear phase noise limiter device DL 30, in manner known to the person skilled in the art, e.g. within a transmission module MT 20 of the kind shown in FIG. 1.

Such a transmission module generally comprises a span of transmission optical fiber 21. By way of example, it may be a standard single mode fiber (SSMF). It could equally well be a large effective area fiber (LEAF™ or TRUE WAVE™) or indeed any other line optical fiber with positive chromatic dispersion. Such a span may have a length of about 100 kilometers. It is followed by an in-line optical amplifier 22 of the erbium doped fiber amplifier (EDFA) type that operates in band C. The purpose of this amplifier is to amplify the optical signal that has suffered attenuation in its mean amplitude value while being conveyed by the optical fiber 21, and that needs to be regenerated regularly.

Nevertheless, it should be observed that any other type of amplifier could be used, in particular a Raman amplifier.

The transmission module MT 20 also comprises chromatic dispersion compensator, typically a dispersion compensating fiber DCF 23 that presents negative chromatic dispersion, and of a length that is selected to compensate exactly for the chromatic dispersion has been accumulated by the optical signal in the fiber 21. As a result, the outlet from the compensation fiber DCF constitutes a zero dispersion point NDP. At this point, the modulated optical signal being conveyed presents a mean amplitude value that is constant, with the ASE noise superposed thereon.

It should be observed that the transmission module MT 20 may also include a second amplifier 24 located downstream from the compensation fiber DCF 23, thereby making it possible to output an optical signal at an amplitude level that matches the input amplitude level required by the amplitude fluctuation suppressor module 32.

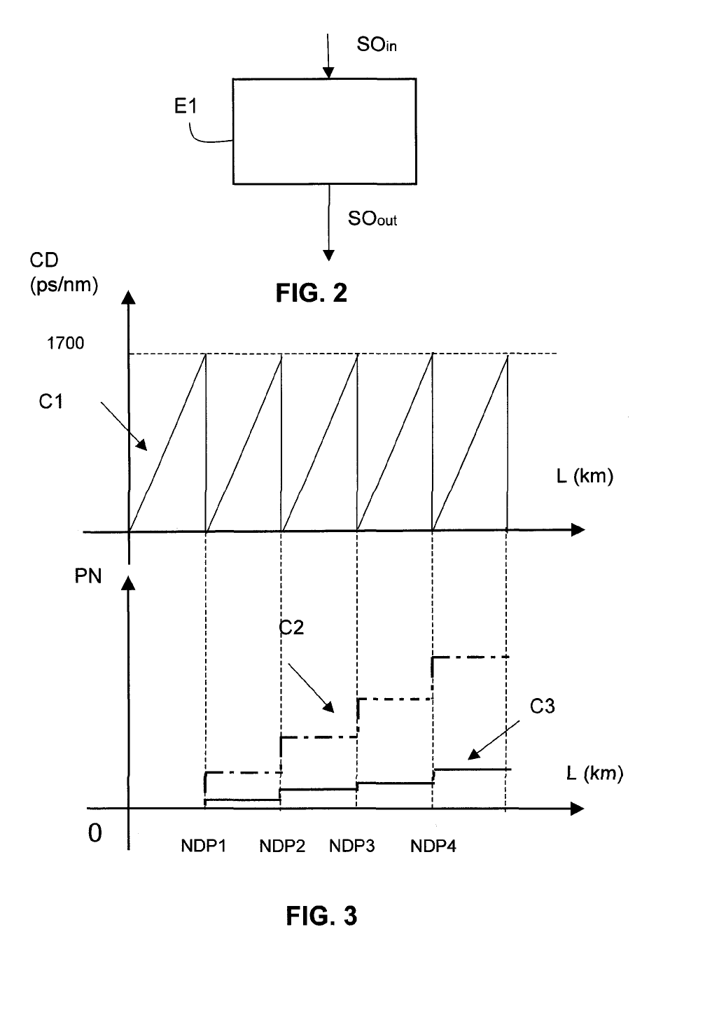

The phase noise limiter device DL 30 implements the steps of a method of limiting non-linear phase noise that is described below with reference to FIG. 2.

On receiving an optical input signal SOᵢₙ, such a method implements a step of suppressing any amplitude fluctuations that affect the optical signal of the M-PSK type. The resulting output optical signal SOₒᵤₜ is “clean”, thereby having the effect of avoiding generating non-linear phase noise in the downstream portion of the transmission line, and thus avoiding such noise accumulating along the line.

FIG. 3 is a diagram plotting a first curve C1 showing how chromatic dispersion varies along the transmission line. It comprises a succession of chromatic dispersion peaks (upstream from the chromatic dispersion compensator) and of zero dispersion points NDP1 to NDP4. A second curve C2 shows diagrammatically how non-linear phase noise can vary along the transmission line in the absence of noise limiter devices according to an aspect of the disclosure. It can be seen that the noise level increases sharply after each fiber span. A third curve C3 shows an example of how phase noise varies when phase noise limiter devices of the disclosure are located at the zero dispersion points NDP1 to NDP4. The increase in the level of the non-linear phase noise is much more limited. It should be observed that depending on the engineering design rules applied by the operator and on the choice of transmission fiber spans, it is possible completely to prevent non-linear phase noise appearing between two of such phase noise limiter devices.

According to an aspect of the disclosure, the noise limiter device DL 30 for suppressing amplitude fluctuations comprise an optical component of the transparent saturable absorber type. By way of example, such a component may be implemented by inserting a saturable absorber in a cavity constituting a multiple wave interferometer. Providing the optical signal received by the device presents a power Pᵢₙ on entry into the device that is greater than a predetermined threshold Pᵢₙ₁, the device peak-limits the power, which is the modulus of the square of the amplitude of the electric field of the signal, to a constant value Pₒᵤₜ₁.

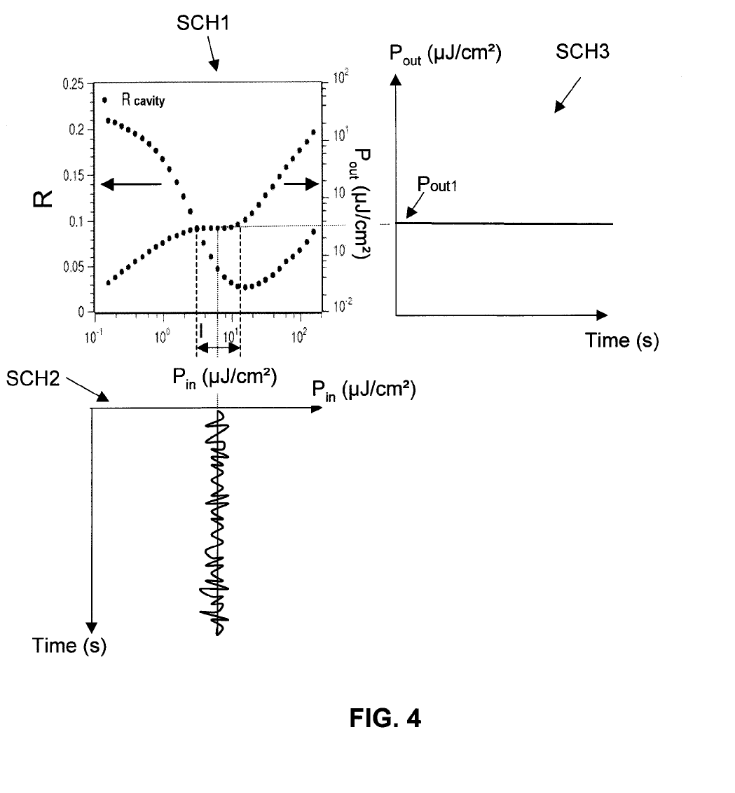

With reference to FIG. 4, there is shown a transfer function for a transparent saturable absorber as constituted in this way. The diagram SCH1 shows variation in the reflectivity R of the cavity and in the output power Pₒᵤₜ from the device as a function of the power Pᵢₙ of the input optical signal. It shows that the curve for variation in the output power Pₒᵤₜ from the device as a function of the power Pᵢₙ of the input optical signal presents a plateau Pₒᵤₜ over a range I of input power values. The diagram SCH2 shows fluctuations in the mean value of the input power Pᵢₙ when its value is included in the range I. The diagram SCH3 shows that the transparent saturable absorber eliminates amplitude fluctuations around the value Pᵢₙ₁ and delivers an output signal of constant power with the value Pₒᵤₜ₁.

An example of an optical transmission system of the disclosure is described below with reference to FIG. 4. The transmission system OTS 100 comprises a transmitter Tx 10 suitable for transmitting an optical signal SO that is phase modulated with an M-PSK type format. It also includes a plurality of transmission modules MT1 to MTN, where N is an integer greater than or equal to 1. In the example of FIG. 4, N is selected to be equal to 6, however aspects of the disclosure are not limited to this particular number. The modules are disposed in groups, a first group being formed by a transmission module 20, that provides a zero dispersion point NDP1, a second group being formed by modules MT 20₂, 20₃, and 20₄ having a zero dispersion point NDP2 at the output therefrom, and a third group formed by transmission modules 20₅ and 20₆, with a zero dispersion point NDP3 at the outlet therefrom.

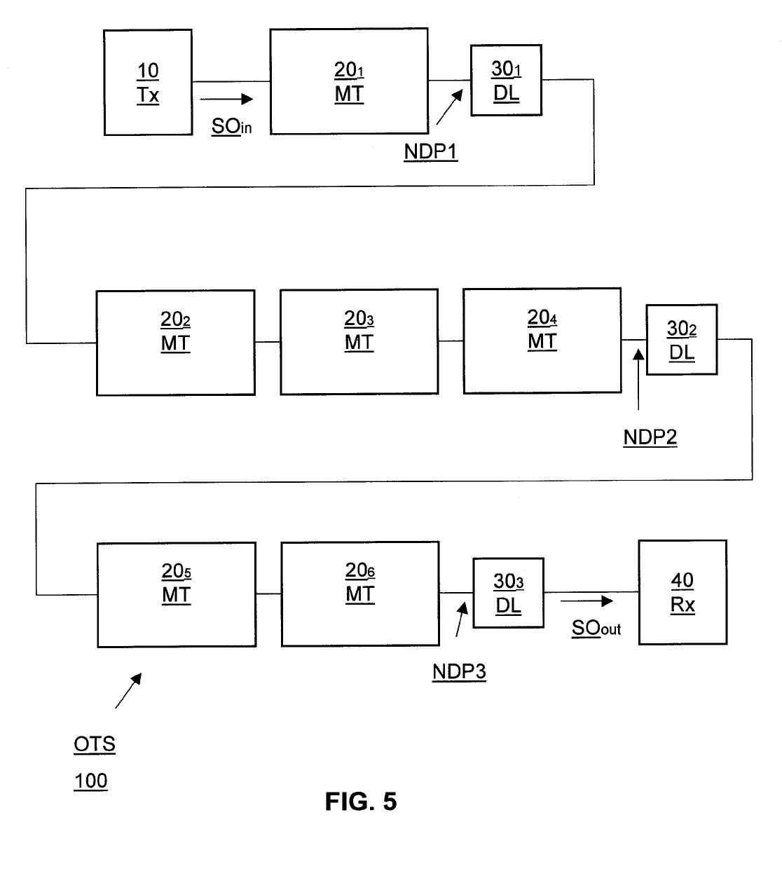

According to the an aspect of the disclosure, the transmission system 100 has a plurality of non-linear phase noise limiter devices DL 30 that are placed regularly along the transmission line. In the example of FIG. 5, three devices DL 30₁, DL 30₂, and DL 30₃ are shown. They are placed respectively at the zero dispersion points NDP1, NDP2, and NPD3.

The transmission system OTS finally includes a receiver Rx 40 suitable for receiving the transmitted optical signal SOₒᵤₜ.

Nevertheless, it should be observed that aspects of the disclosure are not limited to this particular configuration for a transmission system. The example shown in FIG. 5 seeks to illustrate the following points:

the non-linear phase noise limiter device should be placed at a zero dispersion point;

such a zero dispersion point can advantageously be provided by a transmission module as described above;

it is not essential to place a non-linear phase noise limiter device at each zero dispersion point available along a transmission line. In other words, a transmission line of the disclosure may have a plurality of transmission modules in a sequence followed by a single non-linear phase noise limiter device; and

the non-linear phase noise limiter devices are advantageously placed regularly along the transmission line, with the number and the disposition thereof being determined by the engineering design rules for the network in order to achieve a compromise between cost and performance.

Although the present disclosure has been described with reference to one or more examples, workers skilled in the art will recognize that changes may be made in form and detail without departing from the scope of the disclosure and/or the appended claims.

What is claimed is:

1. A non-linear phase noise limiter device for limiting the non-linear phase noise that affects a phase-modulated input optical signal of constant mean amplitude conveyed over a transmission line, wherein the device comprises:
means for suppressing amplitude fluctuations about a mean value in said optical signal, and
wherein the device is placed at a zero dispersion point of the transmission line.

2. The non-linear phase noise limiter device according to claim 1, wherein the means for suppressing amplitude fluctuations are suitable for transforming an input signal presenting a mean amplitude lying within a predetermined range into an output signal presenting a constant output amplitude.

3. The non-linear phase noise limiter device according to claim 1, wherein the means for suppressing amplitude fluctuations are implemented by a transparent saturable absorber type component.

4. A method of limiting non-linear phase noise in a phase-modulated optical signal of constant mean amplitude conveyed over a transmission line, wherein the method comprises:
implementing, at a zero dispersion point in the transmission line, a step of suppressing amplitude fluctuations in said signal about a mean value of said signal.

5. An optical fiber transmission system comprising:
a transmitter suitable for transmitting a phase-modulated optical signal of constant amplitude;
at least one transmission module comprising:
a transmission optical fiber span suitable for conveying the optical signal;
in-line amplifier means for amplifying said optical signal at an output from the optical fiber span; and
means for compensating chromatic dispersion accumulated by the optical signal in said transmission optical fiber span and for delivering an amplified optical signal in which effects of chromatic dispersion are canceled;
at least one phase noise limiter device placed at an output from said transmission module, said device including means for suppressing amplitude fluctuations in said optical signal as detected around a mean value.
